(19) United States
(12) Patent Application Publication
(10) Pub. No.: US 2006/0212550 A1
(43) Pub. Date: Sep. 21, 2006

(54) Information processing apparatus and activation method

(75) Inventor: Hiroyuki Oda, Akishima-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshbia

(21) Appl. No.: 11/372,594

(22) Filed: Mar. 10, 2006

(30) Foreign Application Priority Data
Mar. 15, 2005 (JP) 2005-073766

(51) Int. Cl. G06F 9/00

(52) U.S. Cl. 709/220; 713/2

(57) ABSTRACT

According to one embodiment, there is provided an information processing apparatus including a body to which a plurality of devices are attachable, an input unit which designates one of a first activation mode and second activation mode as an activation mode of the apparatus, a first executing unit which executes first initialization processing of detecting a device attached to the body and initializing the attached device when a power supply of the body is turned on with designation of the first activation mode by the input unit, a storage unit which stores device information indicating the device detected by the first initialization processing, and a second executing unit which executes second initialization processing of initializing the device designated by the device information stored in the storage unit when the power supply of the body is turned on with designation of the second activation mode by the input unit.

### CROSS-REFERENCE TO RELATED APPLICATIONS

This application is based upon and claims the benefit of priority from Japanese Patent Application No. 2005-073766, filed Mar. 15, 2005, the entire contents of which are incorporated herein by reference.

### BACKGROUND

1. Field

One embodiment of the invention relates to an information processing apparatus such as a personal computer or the like and, more particularly, to an information processing apparatus to which a plurality of devices are detachably attached and an activation method used in the apparatus.

2. Description of the Related Art

In recent years, various portable personal computers of laptop or notebook type have been developed. A computer of this type is configured to receive various devices as needed so as to expand its function. To this end, upon power-on of the computer, device detection processing of detecting respective devices attached to the computer must be executed. In the device detection processing, predetermined commands and the like must be issued to all devices to be detected. For this reason, the device detection processing becomes one of large triggers that lower the activation speed of the computer.

Jpn. Pat. Appln. KOKAI Publication No. 2000-298579 (patent reference 1) discloses a technique for executing initial setups of a computer by selectively using a plurality of setup information patterns.

In the computer described in patent reference 1 above, each setup information pattern is permanently determined in advance. For this reason, it is practically difficult to flexibly cope with a change in hardware arrangement of the computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing an example of the system arrangement of the information processing apparatus shown in FIG. 1;

FIG. 3 is an exemplary view for explaining an example of device information stored in the information processing apparatus shown in FIG. 1;

FIG. 4 is an exemplary flowchart for explaining the first half of the sequence of activation processing to be executed by the information processing apparatus shown in FIG. 1; and

FIG. 5 is an exemplary flowchart for explaining the second half of the sequence of activation processing to be executed by the information processing apparatus shown in FIG. 1.

### DETAILED DESCRIPTION

Various embodiments according to the invention will be described hereinafter with reference to the accompanying drawings. In general, according to one embodiment of the invention, there is provided an information processing apparatus including a body to which a plurality of devices are attachable, an input unit which designates one of a first activation mode and second activation mode as an activation mode of the apparatus, a first executing unit which executes first initialization processing of detecting a device attached to the body and initializing the attached device when a power supply of the body is turned on with designation of the first activation mode by the input unit, a storage unit which stores device information indicating the device detected by the first initialization processing, and a second executing unit which executes second initialization processing of initializing the device designated by the device information stored in the storage unit when the power supply of the body is turned on with designation of the second activation mode by the input unit.

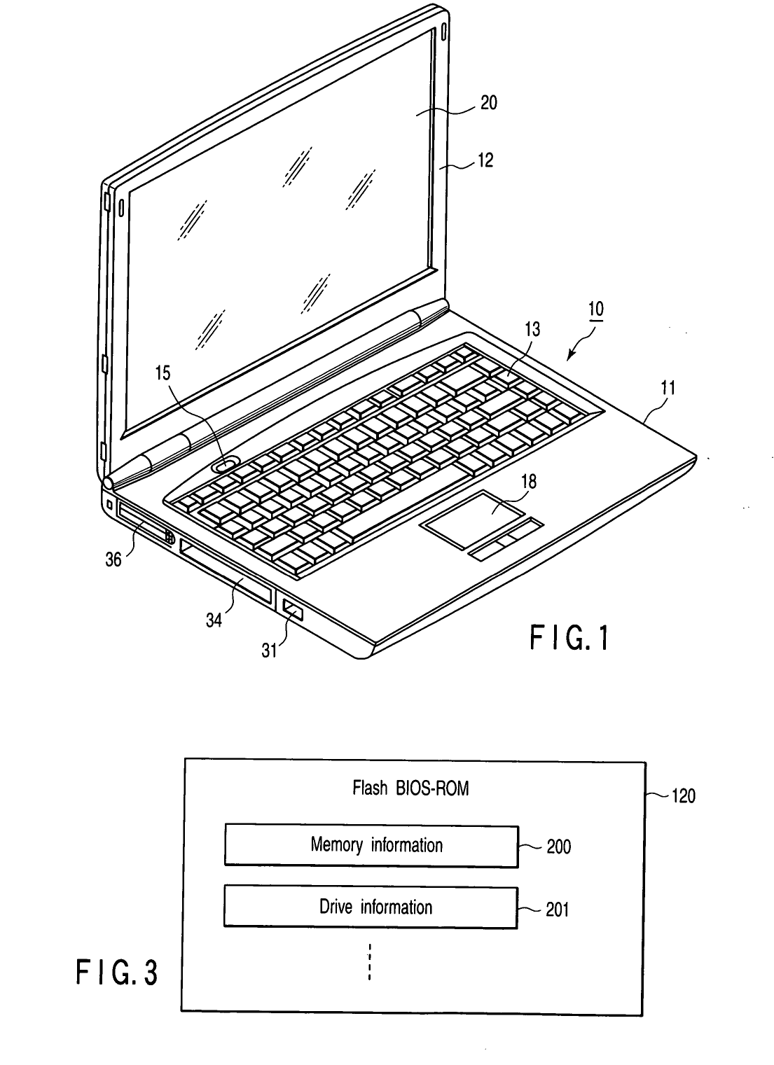

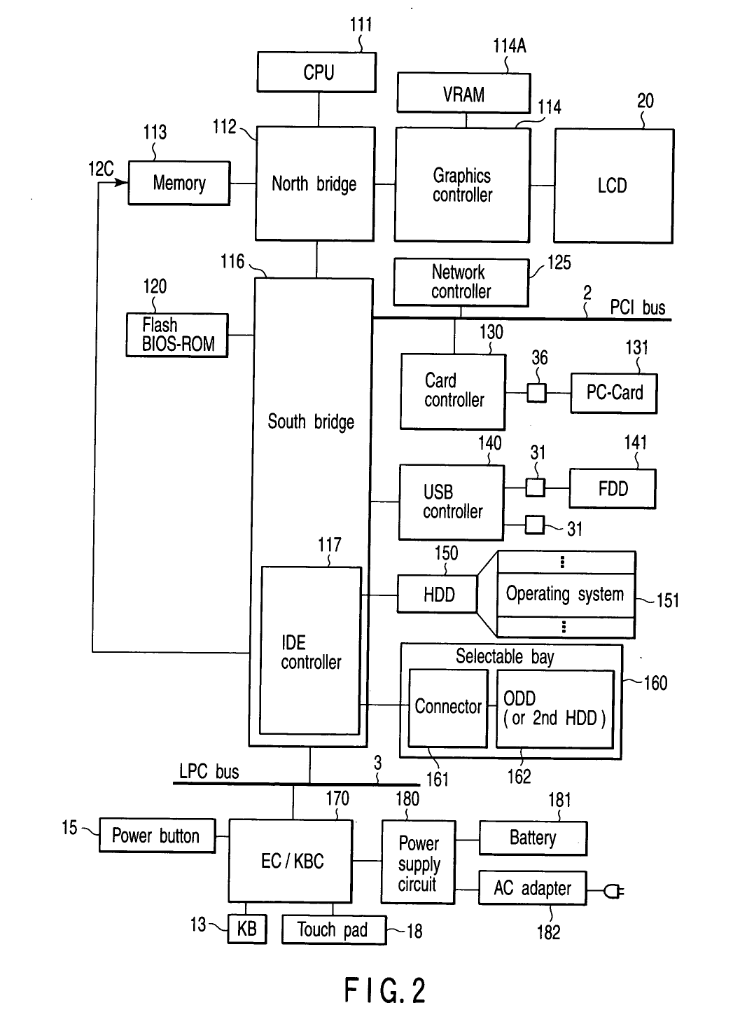

The arrangement of an information processing apparatus according to an embodiment of the present invention will be described below with reference to FIGS. 1 and 2. This information processing apparatus is a portable information processing apparatus which can be driven by a battery, and is implemented as a notebook type personal computer 10.

FIG. 1 is a perspective view when a display unit of the notebook type personal computer 10 is opened. The computer 10 includes a computer main body 11 and a display unit 12. The display unit 12 incorporates a display device comprising a liquid crystal display 20 (LCD). The display screen of the LCD 20 is located at nearly the center of the display unit 12.

The display unit 12 is supported by the computer main body 11, and is attached to the computer main body 11 to be pivotal between an open position where the top surface of the computer main body 11 is exposed and a close position where the display unit 12 covers the top surface of the computer main body 11. The computer main body 11 is a computer apparatus main body having a low-profile box-shaped housing. On the top surface of the computer main body 11, a keyboard 13, a power button switch 15 used to turn on/off the power supply of the computer 10, a touch pad 18, and the like are arranged.

On the side wall of the computer 10, a universal serial bus (USB) port 31, a selectable bay 34, a card slot 36, and the like are mounted. The USB port 31 is a connection port used to connect a USB compatible device. The selectable bay 34 is a drive bay used to selectively mount devices such as an optical disc drive (ODD), hard disk drive (HDD), and the like to the computer main body 11. The card slot 36 is used to mount a card device such as a PC card or the like to the computer main body 11. In this manner, a plurality of devices are attachable to the computer 10.

The computer 10 has two activation modes, i.e., first and second activation modes as those of the computer main body 11. In the first activation mode, a standard power-on self test (POST) processing is executed. In the second activation mode, a simple power-on self test (POST) processing is executed. In this embodiment, the power button switch 15 serves as an input unit that designates the first or second activation mode as that of the computer main body 11. That is, the user can designate one of the first and second activation modes by changing the duration of depression of the power button switch 15.

In the standard POST processing, device detection processing of detecting respective devices (a memory device, a PC card device, a disc drive, and the like) attached to the computer 10 is executed. Then, processing of initializing the detected devices is executed in accordance with the types of detected devices and the like. In the standard POST processing, processing of storing device information indicating the detected devices in a nonvolatile memory is also executed.

In the simple POST processing, the aforementioned device detection processing is skipped, and only devices (the memory device, the PC card device, the disc drive, and the like) designated by the device information already stored in the nonvolatile memory by the standard POST processing are initialized. For this reason, if the hardware arrangement of the computer 10 remains the same after the previous power-off timing of the computer 10, the user can activate the computer 10 at high speed by designating the simple POST processing. If the hardware arrangement of the computer 10 has changed after the previous power-off timing of the computer 10, the user can designate the standard POST processing.

An example of the system arrangement of the computer 10 will be described below with reference to FIG. 2.

The computer 10 comprises a CPU 111, a north bridge 112, a main memory 113, a graphics controller 114, a LCD 20, a south bridge 116, a flash BIOS-ROM 120, a network controller 125, a card controller 130, a USB controller 140, a hard disk drive (HDD) 150, a selectable bay device 160, an embedded controller/keyboard controller IC (KC/KBC) 170, a power supply circuit 180, and the like.

The CPU 111 is a processor which controls the operations of respective components of the computer 10. This CPU 111 executes an operating system 151 and various application programs which are loaded from the HDD 150 onto the main memory 113. The CPU 111 also executes a system simple input output system (BIOS) stored in the flash BIOS-ROM 120. The system BIOS is a program for hardware control. The system BIOS includes a routine for selectively executing the aforementioned the standard POST processing and the simple POST processing, a routine for booting the operating system 151, and the like.

The flash BIOS-ROM 120 is a nonvolatile memory that stores the system BIOS. This flash BIOS-ROM 120 is also used to store device information indicating respective devices detected by the standard POST processing. The device information includes a memory information 200 and a drive information 201, as shown in FIG. 3. The memory information 200 indicates a memory device that serves as an expanded memory of the main memory 113. The memory information 200 includes connection status information and type information. The connection status information indicates whether or not the memory device is attached to the computer 10. The type information indicates the type of memory device attached to the computer 10. The drive information 201 is information indicating bootable devices (drive devices such as, e.g., the FDD 141, the HDD 150, the selectable bay device 160, and the like) attached to the computer 10. The drive information 201 includes connection status information and type information. The connection status information indicates whether or not that bootable device is attached to the computer 10 for each bootable device. The type information indicates the type of bootable device attached to the computer 10 for each bootable device.

The north bridge 112 is a device bridge that connects a local bus of the CPU 111 and the south bridge 116. The north bridge 112 also has a function of executing a communication with the graphics controller 114 via an accelerated graphics port (AGP) bus or the like. Furthermore, the north bridge 112 incorporates a memory controller which controls the main memory 113 (including the expanded memory device).

The graphics controller 114 is a display controller which controls the LCD 20 used as the display monitor of the computer 10. This graphics controller 114 controls to display data stored in a VRAM 114A on the LCD 20.

The south bridge 116 incorporates an integrated drive electronics (IDE) controller 117 which controls the HDD 150, the selectable bay device 160, and the like. The south bridge 116 is connected to a peripheral component interconnect (PCI) bus 2 and a low pin count (LPC) bus 3. The south bridge 116 is also connected to the USB controller 140.

The HDD 150 is a storage device which stores various kinds of software and data. The HDD 150 pre-stores the operating system 151.

The selectable bay device 160 comprises, e.g., a connector 161 and optical disc drive (ODD) 162. The ODD 162 is a drive unit for driving optical storage media such as a digital versatile disc (DVD), a compact disc (CD), and the like. In place of the ODD 162, a selectable bay device 160 which incorporates the second HDD in addition to the HDD 150 may be used.

The USB controller 140 has a function of controlling a USB device connected to the USB port 31. To the USB port 31, for example, a flexible disc drive (FDD) 141 is connected as needed.

To the PCI bus 2, the network controller 125 and card controller 130 are connected. The network controller 125 is a communication device used to connect the computer 10 to a network. The card controller 130 controls a card device such as a PC card 131 or the like inserted into the card slot 36.

The embedded controller/keyboard controller IC (EC/KBC) 170 is a 1-chip microcomputer on which an embedded controller for power management and a keyboard controller that controls the keyboard (KB) 13, the touch pad 18, and the like are integrated. The embedded controller/keyboard controller IC (EC/KBC) 170 has a function of turning on/off the power supply of the computer 10 in response to the user's operation of the power button switch 15 in collaboration with the power supply circuit 180. The power supply circuit 180 generates a system power supply to be supplied to respective components of the computer 10 using a battery 181 or an external power supply supplied via an AC adapter 182. Upon depression of the power button switch 15 by the user, the embedded controller/keyboard controller IC 170 detects the duration of depression of the power button switch 15, and generates wake-up trigger information that designates one of the first activation modes and the second activation modes in accordance with the detected duration of depression. This wake-up trigger information is stored in a register in the embedded controller/keyboard controller IC 170 in this embodiment. For example, when the duration of depression of the power button switch 15 by the user is longer than a predetermined period (long depression), the wake-up trigger information that designates the first activation mode is stored in the embedded controller/keyboard controller IC 170. On the other hand, when the duration of depression of the power button switch 15 by the user is equal to or shorter than the predetermined period, the wake-up trigger information that designates the second activation mode is held in the embedded controller/keyboard controller IC 170. Upon reception of a wake-up trigger acquisition request from the CPU 111, the embedded controller/keyboard controller IC 170 outputs the stored wake-up trigger information to the CPU 111.

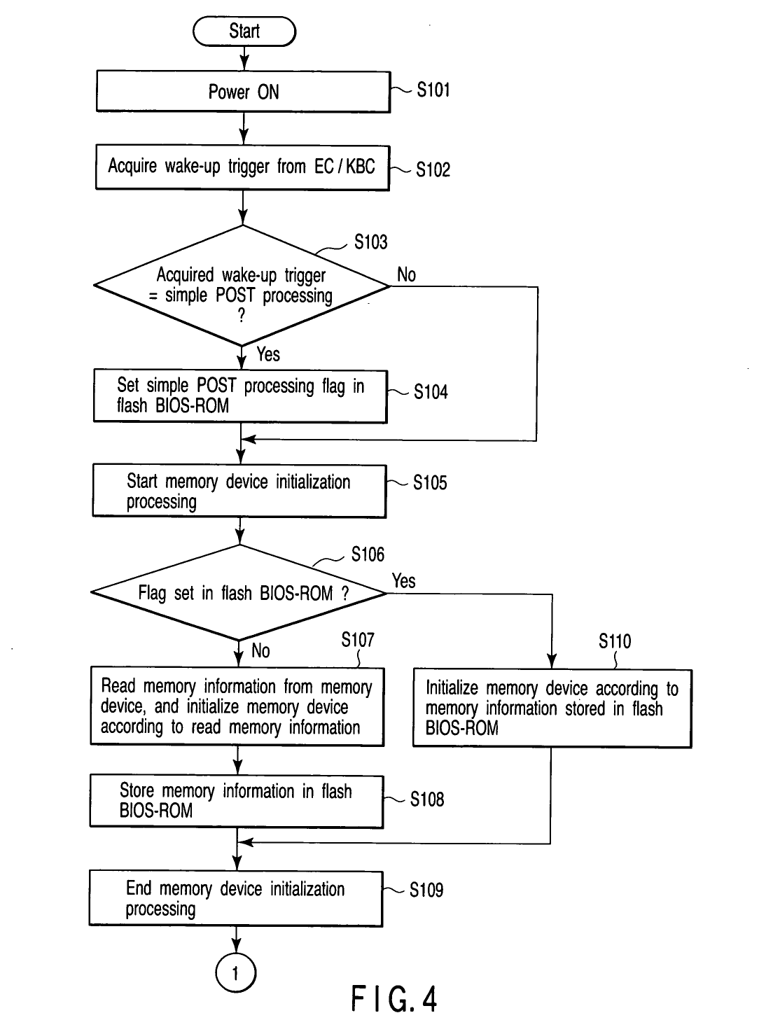

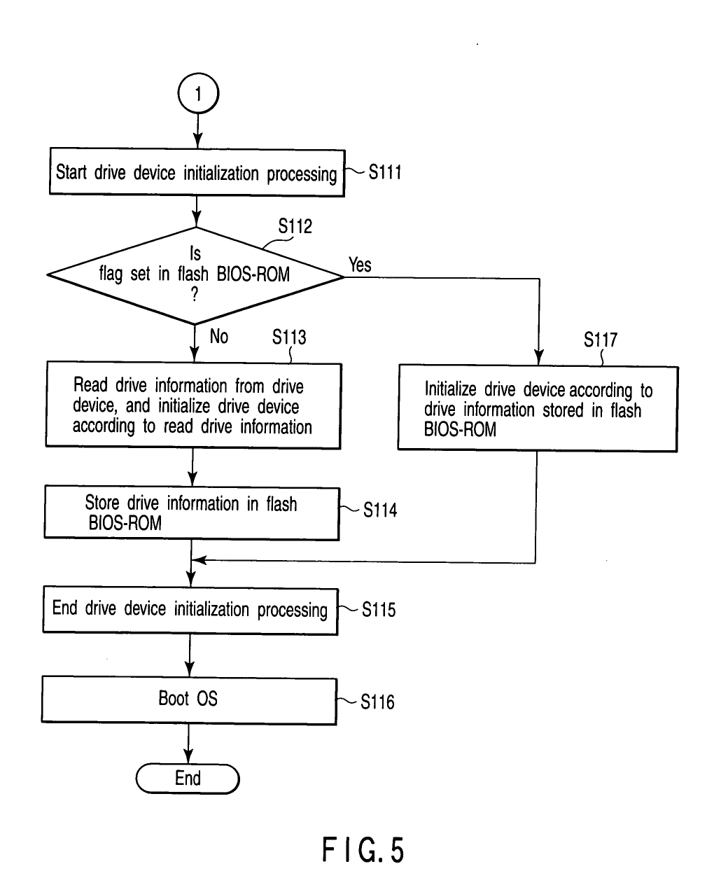

The sequence of the activation processing of the computer 10 to be executed by the system BIOS will be described below with reference to the flowcharts of FIGS. 4 and 5.

Upon depression of the power button switch 15 by the user, the power supply of the computer 10 is turned on (block S101). Upon power-on of the computer 10, the CPU 111 executes the following processing in accordance with the system BIOS.

The CPU 111 acquires the wake-up trigger information from the embedded controller/keyboard controller IC 170 (block S102). The CPU 111 determines according to the acquired wake-up trigger information whether or not the wake-up trigger of the computer 10 is that which allows the simple POST processing, i.e., whether or not the activation mode designated upon operation of the power button switch 15 is the second activation mode (block S103). If the acquired wake-up trigger is that which can execute the simple POST processing (YES in block S103), the CPU 111 determines that the power supply of the computer main body 11 is turned on with designation of the second activation mode by the power button switch 15, and sets a simple POST processing permission flag in the flash BIOS-ROM 120 (block S104). On the other hand, if the acquired wake-up trigger is not that which can execute the simple POST processing (NO in block S103), the CPU 111 determines that the power supply of the computer main body 11 is turned on with designation of the first activation mode by the power button switch 15, and skips the processing in block S104.

Next, the CPU 111 starts a memory device initialization processing (block S105). In the memory device initialization processing, processing of initializing the expanded memory device used as the main memory 113 is executed.

The CPU 111 determines if the simple POST processing permission flag is set in the flash BIOS-ROM 120 (block S106). If no simple POST processing permission flag is set in the flash BIOS-ROM 120 (NO in block S106), the CPU 111 executes processing of reading memory information (an indicating the memory size, a bank configuration, an access timing, and the like) indicating the type of the expanded memory device from an EEPROM mounted on the expanded memory device via an Inter-integrated circuit (12C) bus so as to detect the expanded memory device attached to the computer 10 (block S107). In block S107, the CPU 111 executes processing of initializing the expanded memory device in accordance with the read memory information. If no memory information can be read, it is determined that no expanded memory device is attached, and the initialization processing of the expanded memory device is skipped.

After that, the CPU 111 stores type information and connection status information associated with the expanded memory device in the flash BIOS-ROM 120 as the memory information 200 (block S108).

On the other hand, if the simple POST processing permission flag is set in the flash BIOS-ROM 120 (YES in block S106), the CPU 111 initializes the expanded memory device designated by the memory information 200 stored in the flash BIOS-ROM 120 (block S110). In this case, initialization of the expanded memory device is executed according to the type information included in the memory information 200. If the connection status information included in the memory information 200 indicates that no expanded memory device is attached to the computer 10, even when the expanded memory device is actually attached to the computer 10, the initialization processing is skipped.

Upon completion of the memory device initialization processing (block S109), the CPU 111 starts drive device initialization processing (block S111 in FIG. 5). The drive device initialization processing is processing of initializing drive devices (bootable devices) such as the FDD 141, the HDD 151, the selectable bay device 160, and the like connected to the computer 10.

The CPU 111 determines if the simple POST processing permission flag is set in the flash BIOS-ROM 120 (block S112). If no simple POST processing permission flag us set (NO in block S112), the CPU 111 reads drive information (the indicating the storage size, a supported DMA transfer mode, and the like) such as a device ID from each of the drive devices by issuing, e.g., an IDE command or the like to each drive device, so as to detect the drive devices attached to the computer 10 (block S113). In block S113, the CPU 111 also executes processing of initializing each detected drive device in accordance with the drive information read from that drive device. As for the drive device from which no drive information can be read, it is determined that the drive device of interest is not attached, and the initialization processing is skipped. After that, the CPU 111 stores the connection status information and the type information associated with each drive device in the flash BIOS-ROM 120 as the drive information 201 (block S114).

On the other hand, if the simple POST processing permission flag is set (YES in block S112), the CPU 111 initializes respective drive devices whose existence is indicated by the drive information 201 stored in the flash BIOS-ROM 120 (block S117). In this case, initialization of each drive device is executed according to the type information of the corresponding device included in the drive information 201. If the connection status information included in the drive information 201 indicates that no drive device is attached to the computer 10, even when that drive device is actually attached to the computer 10, its initialization processing is skipped.

Upon completion of the drive device initialization processing (block S115), the CPU 111 executes processing of booting the operating system (block S116). In block S116, the CPU 111 selects a bootable device that should boot the operating system from the initialized bootable devices in accordance with a boot priority order information. For example, when the boot priority order corresponds to that of, e.g., the FDD, the HDD, and the ODD, if the FDD has already been initialized, and a bootable medium is inserted into the FDD, the operating system is booted from the FDD. When no FDD is connected, or when the FDD is connected but it is not initialized, the operating system 151 is booted from the HDD 150.

As described above, in this embodiment, the standard POST processing and simple POST processing are selectively executed in accordance with the operation of the power button switch (power switch) 15 by the user. Hence, a change in hardware arrangement of the computer 10 can be flexibly coped with, and the activation processing of the computer 10 can be speeded up.

In this embodiment, the activation mode is switched depending on the duration of depression of the power button switch 115. Alternatively, two power switches, i.e., a first power button switch which designates the first activation mode, and a second power button switch which designates the second activation mode may be provided to the computer main body 11. In this case, when the power supply of the computer 10 is turned on upon operation of the first power button switch, the standard POST processing is executed. When the power supply of the computer 10 is turned on upon operation of the second power button switch, the simple POST processing is executed.

Furthermore, the activation mode may be switched by operating a predetermined key on the keyboard 13 simultaneously with power-on of the computer 10.

In this embodiment, the processing of storing device information detected by the standard POST processing is executed during the standard POST processing. Alternatively, the system BIOS may store the device information in the flash BIOS-ROM 120 upon power-off of the computer 10. In this way, the activation processing can be speeded up by the time required to write the device information in the flash BIOS-ROM 120.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a body to which a plurality of devices are attachable;
an input unit which designates one of a first activation mode and second activation mode as an activation mode of the apparatus;
a first executing unit which executes first initialization processing of detecting a device attached to the body and initializing the attached device when a power supply of the body is turned on with designation of the first activation mode by the input unit;
a storage unit which stores device information indicating the device detected by the first initialization processing; and
a second executing unit which executes second initialization processing of initializing the device designated by the device information stored in the storage unit when the power supply of the body is turned on with designation of the second activation mode by the input unit.

2. The apparatus according to claim 1, wherein:
the input unit includes a power switch; and
the apparatus further comprises a controller which designates one of the first activation mode and the second activation mode in accordance with a duration of an operation of the power switch.

3. The apparatus according to claim 1, wherein the input unit includes:
a first power switch which designates the first activation mode; and
a second power switch which designates the second activation mode.

4. The apparatus according to claim 1, wherein the first initialization processing includes processing of storing the device information in the storage unit.

5. The apparatus according to claim 1, wherein:
the first initialization processing includes processing of detecting a memory device attached to the body and processing of initializing the detected memory device; and
the second initialization processing includes processing of initializing a memory device designated by the device information.

6. The apparatus according to claim 1, wherein:
the first initialization processing includes processing of detecting a bootable device attached to the body and processing of initializing the detected bootable device; and
the second initialization processing includes processing of initializing a bootable device designated by the device information.

7. An activation method of activating an information processing apparatus having a body to which a plurality of devices are attachable, the method comprising:
designating one of a first activation mode and a second activation mode as an activation mode of the apparatus;
executing first initialization processing of detecting a device attached to the body and processing of initializing the attached device when a power supply of the body is turned on with designation of the first activation mode;
storing a device information indicating the device detected by the first initialization processing; and
executing second initialization processing of initializing the device designated by the stored device information when the power supply of the body is turned on with designation of the second activation mode.

8. The method according to claim 7, wherein the designating includes designating one of the first activation mode and the second activation mode in accordance with a duration of an operation of a power switch provided to the body.

9. The method according to claim 7, wherein the storing includes storing the device information in a nonvolatile memory device provided to the body when power-off of the body.

10. The method according to claim 7, wherein:
the first initialization processing includes processing of detecting a memory device attached to the body and processing of initializing the detected memory device; and
the second initialization processing includes processing of initializing a memory device designated by the device information.

11. The method according to claim 7, wherein:
the first initialization processing includes processing of detecting a bootable device attached to the body and processing of initializing the detected bootable device; and
the second initialization processing includes processing of initializing a bootable device designated by the device information.
